(19) United States
(12) Patent Application Publication
(10) Pub. No.: US 2024/0165838 A1
(43) Pub. Date: May 23, 2024

(54) KNIFE STORAGE DEVICE

(71) Applicant: Seung Soo YOUN, Chungcheongnam-do (KR)

(72) Inventor: Seung Soo YOUN, Chungcheongnam-do (KR)

(21) Appl. No.: 18/282,831

(22) PCT Filed: Feb. 24, 2022
(86) PCT No.: PCT/KR2022/002722

§ 371 Date: Sep. 19, 2023

(30) Foreign Application Priority Data
Mar. 19, 2021 (KR) 10-2021-0036087

(51) Int. Cl. B26B 29/02; A47G 21/14

(52) U.S. Cl. CPC B26B 29/02; A47G 21/14

(57) ABSTRACT

A knife storage device includes a storage main body in which a knife having a blade and a handle is stored, wherein the storage main body has a blade accommodation part in which the blade is accommodated and a handle loading part in which the handle is loaded, and the handle is loaded in the handle loading part so that the knife is stably stored.

### BACKGROUND

The present invention relates to a knife storage device and particularly to a knife storage device which can hold knives stably and prevent damage to the blades of the knives when storing the knives.

In general, knives used for cooking are indispensable at home or in restaurants, and are usually divided into a blade part and a handle. According to the functions of knives, the blade portion of a knife can be processed to be used, or the blade portion of the knife can be shaped differently. The knives can be divided into many different types, including commonly used kitchen knives, Chinese kitchen knives, raw fish knives, serrated knives or the like, depending on places where they are used or people who use them.

Knife storage devices, generally used for home or commercial use, allow knives to be stored and organized by being inserted into partitioned spaces, and includes insertion holes, into which knives are inserted so as to prevent injuries caused by blades, and a holding space, in which the knives are placed so as to prevent the blades from being exposed to the outside, thereby preventing injury to users.

In most cases, the knives are cleaned after use and then inserted into such a storage device before they are completely dry. Therefore, there are problems in that most blade holding spaces in the knife storage devices have a closed structure, so damage such as corrosion may occur on blade portions depending on the moisture on the knives and the surrounding environment, and the blade portions are prone to breeding bacteria that can cause food poisoning or are harmful to humans.

### SUMMARY OF THE INVENTION

The present invention is intended to solve the above problems and aims to provide a knife storage device, which can store knives stably so as to prevent users from being injured by blades while preventing damage to the blades due to moisture, when storing the knives.

In order to achieve the above purpose, according to the present invention, there is provided a knife storage device, including a storage main body in which each knife having a blade and a handle is stored, wherein the storage main body has a blade accommodation part in which the blade is accommodated and a handle loading part in which the handle is loaded, and the knife can be stably stored with the handle seated on the handle loading part.

In addition, the handle loading part includes a first handle loading part provided at one side of the blade accommodation part, and a second handle loading part provided at the other side of the blade accommodation part, so that a plurality of knives can be intersectingly stored.

In addition, the blade accommodation part has central slots which are formed at predetermined intervals in a longitudinal direction and in which blades are accommodated, the first handle loading part has a first protection slot in which a blade end of a knife can be accommodated, the handle of the knife being held in the second handle loading part, and the second handle loading part has a second protection slot in which a blade end of a knife can be accommodated, the handle of the knife being held in the first handle loading part, wherein the first protection slot and the second protection slot are formed alternately at points respectively corresponding to the central slots.

In addition, the first handle loading part and the second handle loading part are provided to be spaced apart from the blade accommodation part and are formed to have open bottom portions together with the blade accommodation part, and the storage main body further includes a first support part for connecting lower portions of the central slots and a lower portion of the first protection slot, a second support par for connecting the lower portions of the central slots and a lower portion of the second protection slot, and a third support part for connecting lower ends of the center in the longitudinal direction of the blade accommodation part.

In addition, the handle loading part (200) is formed to be inclined downward toward the blade accommodation part (300), so that the handles (710) are loaded downward on the handle loading part (200).

According to the present invention, the handle loading part allows knives to be stored and seated stably, and even if cleaned knives are directly stored in the blade accommodation part, the knives can be naturally dried through the storage main body and the blade accommodation part, which have open structures, so that blade damage and bacterial growth can be prevented and the knives can be stored more hygienically.

In addition, as the protection slots are formed intersectingly, knives can be stored crosswise, allowing more knives to be stored, and the blade portions of the knives are prevented from being exposed to users, thereby preventing injury to the users.

### BRIEF DESCRIPTION OF THE DRAWINGS

FIG. 1 is a perspective view of a knife storage device according to an embodiment of the present invention.

FIG. 2 is an exemplary view showing a knife being stored in a knife storage device according to an embodiment of the present invention.

FIG. 3 is an exemplary view for explaining elements formed inside a storage main body of a knife storage device according to an embodiment of the present invention.

FIG. 4 shows a plan view of a knife storage device according to an embodiment of the present invention and a cross-sectional view taken along line A-A′.

FIG. 5 shows a plan view of a knife stored in a knife storage device according to an embodiment of the present invention and a cross-sectional view taken along line B-B′.

### DETAILED DESCRIPTION OF THE INVENTION

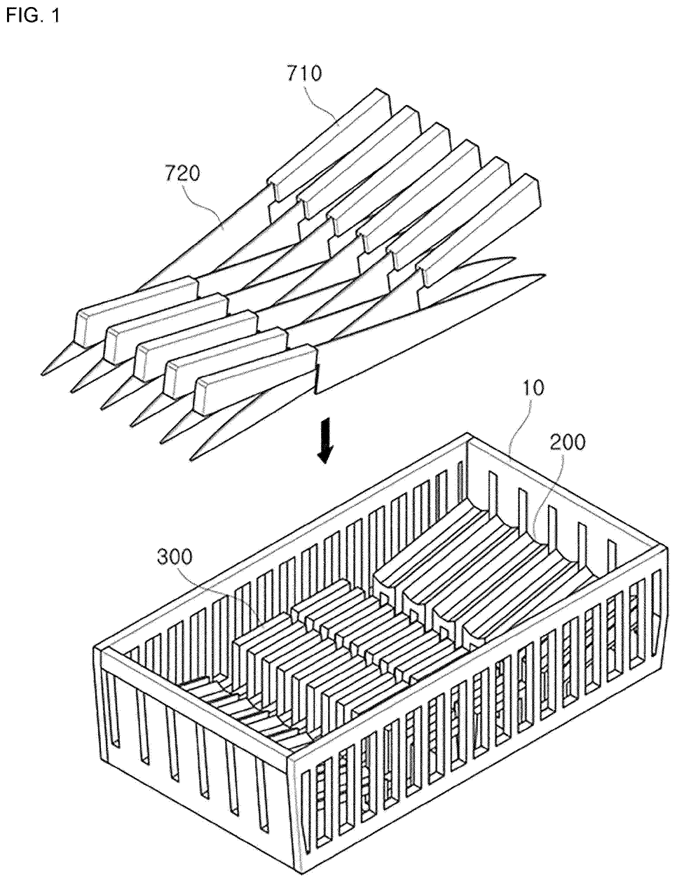

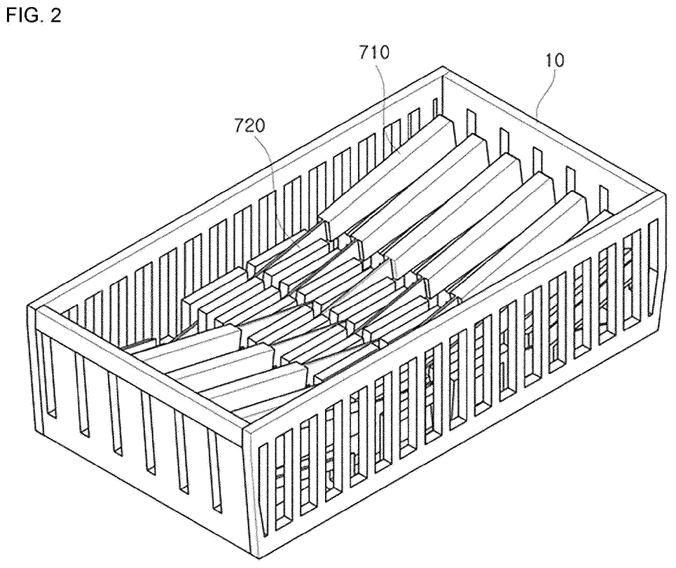

As shown in FIG. 1 to FIG. 5, according to the present invention, a knife storage device A, basically includes a storage main body 10 with a blade accommodation part 300 and a handle loading part 200 provided therein.

As shown in FIG. 1 to FIG. 5, the storage main body 10 is formed in a cylindrical shape, in which an upper surface portion is open and the width thereof narrows downward, and has a bottom surface portion open, so that a plurality of such storage main bodies 10 can be stacked.

Herein, a plurality of through holes are formed in a side surface of the storage main body 10 so as to facilitate ventilation inside the storage main body 10, thereby allowing knives stored in the storage main body 10 to dry naturally. In addition, a plurality of through holes formed in an outer wall may be formed in a shape that allows blades 720 to be inserted into the storage main body 10 from the outside, wherein the shape of the through holes is not limited.

The blade accommodation part 300, into which the stored blades 720 are inserted and accommodated, has a barrel shape with empty inside and is provided inside of the storage main body 10, wherein one end of the blade accommodation part 300 is fixed to one side of the storage main body 10 and the other end is fixed to the other side of the storage main body 10 corresponding to the one side of the storage main body 10. In addition, the blade accommodation part 300 has a longitudinal cross-section that is opened downward, allowing moisture on the blades 720 accommodated inside to fall downward, or ensuring ventilation through the open portion. Furthermore, the blade accommodation part 300 is formed so that the one end and the other end are open so as to communicate with the through holes formed in the side surface of the storage main body 10, thereby promoting the natural dry of the blades 720. In addition, the blade accommodation part 300 may be formed to become wider in the downward direction, so that a plurality of blade accommodation parts 300 can overlap when a plurality of storage main bodies 10 are stacked.

The blade accommodation part 300 has a central slot 310 which is formed through the entire width from an upper surface to a certain depth so that the blade 720 can be inserted thereinto, wherein a plurality of central slots 310 may be formed at predetermined intervals in the longitudinal direction of the blade accommodation part 300. Accordingly, a plurality of blades 720 can be accommodated in the plurality of central slots 310.

The handle loading part 200 is adjacent to the blade accommodation part 300 or is spaced apart from the blade accommodation part 300 at a predetermined interval so as to be provided inside the storage main body 10 at a predetermined distance, and the handle 710 of the knife of which the blade is accommodated in the blade accommodation part 300 is provided inside the handle loading part 200.

Specifically, the handle loading part 200 may be formed in a direction in which the blade accommodation part 300 is provided from a side perpendicular to the sides of the storage body 10 where the one end and the other end of the blade accommodation part 300 are fixed. In addition, the upper surface of the handle loading part 200 is formed to be inclined downward toward the direction in which the blade accommodation part 300 is provided, so that water on the handle 710 is guided to fall downward along the upper surface, thereby allowing the blade 720 to dry quickly.

A seating surface 201 on which the handle 710 is seated may be formed on the upper surface of the handle loading part 200, wherein the handle seating surface 201 is formed in a concave shape so as to correspond to a lower portion of the handle 710, thereby allowing the handle 710 to be stably seated.

The handle loading part 200 may include a first handle loading part 210 provided at one side of the blade accommodation part 300 and a second handle loading part 220 provided at the other side of the blade accommodation part 300. Herein, the first handle loading part 210 and the second handle loading part 220 may be provided to be spaced apart from the blade accommodation part 300.

As the first handle loading part 210 and the second handle loading part 220 are provided at both sides of the blade accommodation part 300, a knife can be stored so that the blade 720 is accommodated in the blade accommodation part and the handle 710 is seated on the first handle loading part 210, or a knife can be stored so that the blade 720 is accommodated in the blade accommodation part and the handle 710 is seated on the second handle loading part 220.

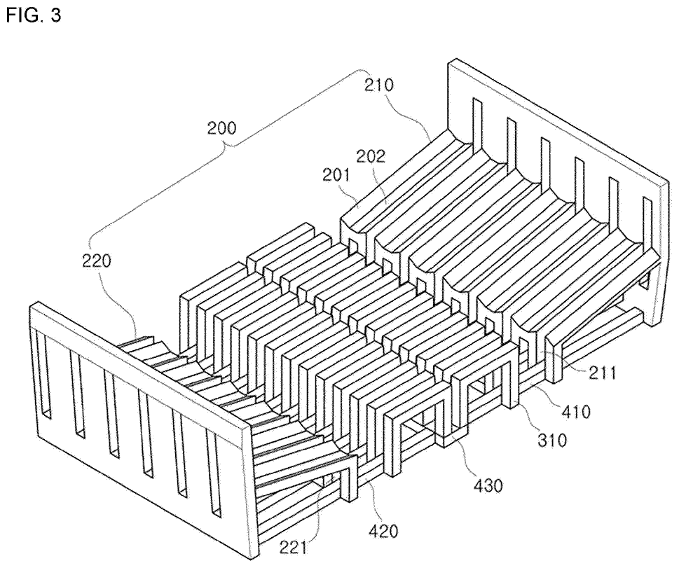

As shown in FIG. 3 to FIG. 5, the handle loading part 200 may have a protection slot into which an end portion of the blade 720 can be inserted. Accordingly, a plurality of protection slots may be formed in each of the first handle loading part 210 and the second handle loading part 220 at predetermined intervals in the longitudinal direction of the handle loading part 200.

As an example, the protection slot may include a first protection slot 211 formed in the first handle loading part 210 and a second protection slot 221 formed in the second handle loading part 220, wherein the first protection slot 211 and the second protection slot 221 may be formed alternately at points corresponding to the central slots 310. Therefore, a plurality of knives can be stored with their blades facing in different directions. For example, when the length of the knife with the handle 710 seated on the first handle loading part 210 is long, the end portion of the blade 720 is accommodated inside the second protection slot 221 formed in the second handle loading part 220. In addition, when the length of the knife with the handle 710 seated on the second handle loading part 220 is long, the end of the blade 720 is accommodated inside the first protection slot 211 formed in the first handle loading part 210. Accordingly, when the knife is stored, injury to users due to the tip portion of the blade 720 can be prevented and the tip portion of the blade 720 can be protected.

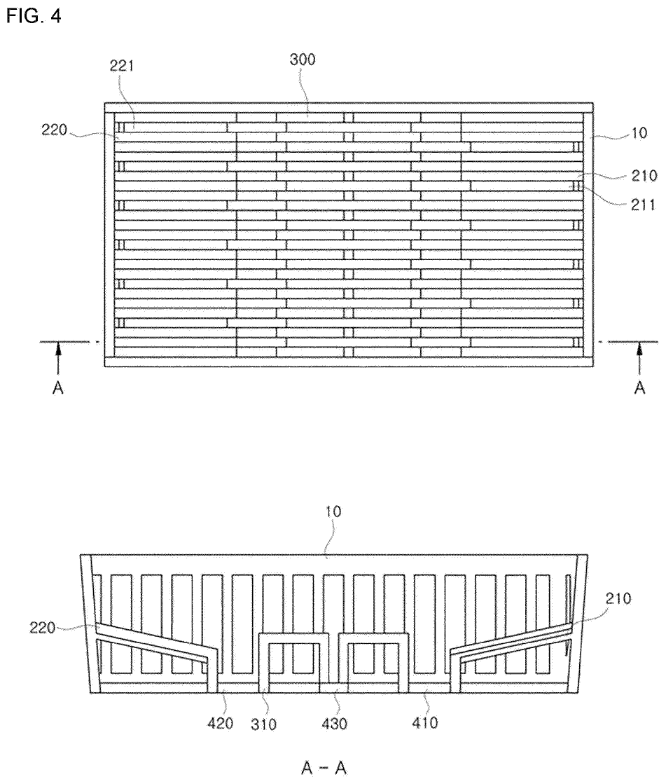

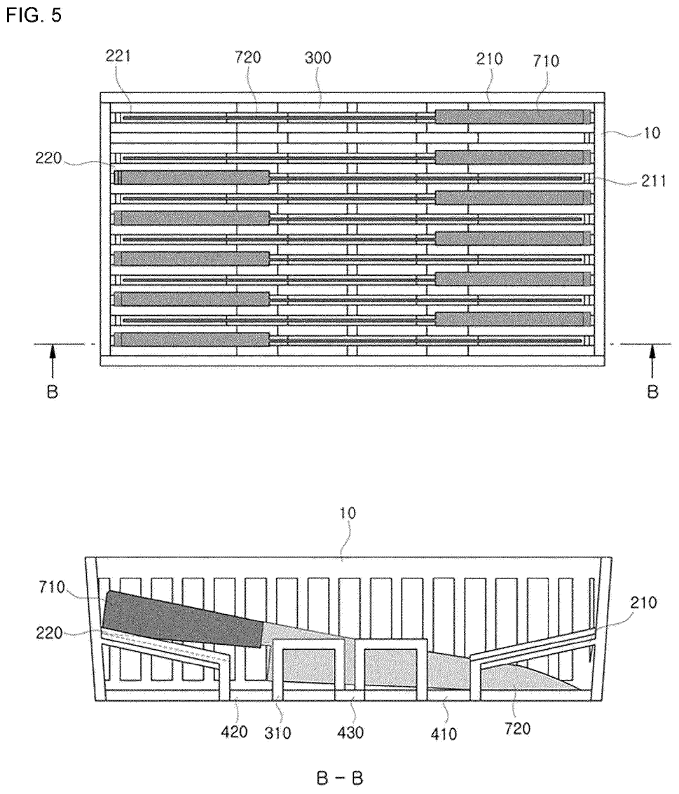

In addition, as shown in FIG. 4 and FIG. 5, the storage main body 10 may include a support part for preventing a knife from falling through the open bottom surface portion when the knife is stored. The support part may be formed to connect a gap between the first handle loading part 210 and the second handle loading part 220 and the blade accommodation part 300 formed apart from the first handle loading part 210 and the second handle loading part 220, and between the first handle loading part 210 and the second handle loading part 220 at positions corresponding to the positions where the central slots 310 of the blade accommodation part 300 are formed.

A first support part 410 may be formed between the first protection slot 211 corresponding to the central slot 310 and the blade accommodation part 300 spaced apart from the first protection slot 211, and a second support part 420 may be formed between the second protection slot 221 corresponding to the central slot 310 and the blade accommodation part 300.

In addition, when the width of the blade accommodation part 300 is formed long, a third support part 430 for connecting lower ends of the center of the blade accommodation part 300 in the longitudinal direction of the blade accommodation part 300.

Referring to FIG. 5, the blade 720 is shown supported by and seated on the first support part 410, wherein it can be noted that as the handle 710 is seated in the second handle loading part 220, the blade 720 is held in the central slot 310 of the blade accommodation part 300 and seated on the first support part 410 and third support part 430, and the tip portion of the blade 720 is inserted into the first protection slot 211, wherein the knife held by the support part can be prevented from falling out in the bottom surface direction. To the contrary, when the handle 710 is seated in the first handle loading part 210, the blade 720 is held in the central slot 310 of the blade accommodation part 300 and seated on the second support part 420 and the third support part 430, and the tip portion of the blade 720 is inserted into the second protection slot 221, wherein the knife held by the support part can be prevented from falling out in the bottom surface direction.

Additionally, as an additional embodiment of the present invention, a lid may be formed so as to cover the upper surface of the open storage main body 10. The knives can be stored while the open upper surface of the storage main body 10 is covered with the lid. Therefore, when the knife storage device A collides with an object or falls, it is possible to prevent the knives from falling outside the knife storage device A. The lid can be coupled to the storage main body 10 with a separate fastening structure, and a handle may be provided on the lid so as to allow the knife storage device A to be readily transported.

### BRIEF EXPLANATION OF REFERENCE NUMERALS

A: Knife storage device 10: Storage main body
200: Handle loading part 201: Seating surface
202: Seating groove 210: First handle loading part
211: First protection slot 220: Second handle loading part
221: Second protection slot
300: Blade accommodation part 310: Central slot
410: First support part 420: Second support part
430: Third support part
420: Second support part
710: Knife handle 720: Blade

What is claimed is:

1. A knife storage device, comprising a storage main body in which knives each having a blade and a handle are stored,
wherein the storage main body has blade accommodation parts in which the blades are accommodated and handle loading parts in which the handles are loaded,
the handle of the knife is loaded in the handle loading part,
the handle loading part includes a first handle loading part provided at one side of the blade accommodation part, and a second handle loading part provided at the other side of the blade accommodation part, so that a plurality of knives are intersectingly stored,
the blade accommodation part has central slots which are formed at predetermined intervals in a longitudinal direction and in which blades are accommodated,
the first handle loading part has a first protection slot in which a blade end of a knife can be accommodated, the handle of the knife being held in the second handle loading part,
the second handle loading part has a second protection slot in which a blade end of a knife can be accommodated, the handle of the knife being held in the first handle loading part,
the first protection slot and the second protection slot are formed alternately at points respectively corresponding to the central slots,
the first handle loading part and the second handle loading part are provided to be spaced apart from the blade accommodation part and are formed to have open bottom portions together with the blade accommodation part, and
the storage main body further includes
a first support part for connecting lower portions of the central slots and a lower portion of the first protection slot,
a second support par for connecting the lower portions of the central slots and a lower portion of the second protection slot, and
a third support part for connecting lower ends of the center in the longitudinal direction of the blade accommodation part.

2. The knife storage device according to claim 1, wherein the handle loading part (200) is formed to be inclined downward toward the blade accommodation part (300), so that the handles (710) are loaded downward on the handle loading part (200).
